(19) United States
(12) Patent Application Publication
(10) Pub. No.: US 2008/0148410 A1
(43) Pub. Date: Jun. 19, 2008

(54) Software Installation Authorization System

(76) Inventor: Robert Allen Wilson, Shawnee, KS (US)

Correspondence Address: ROBERT A. WILSON, 5316 ALBERVAN, SHAWNEE, KS, 66216, US

(21) Appl. No.: 11/611,877

(22) Filed: Dec. 17, 2006

(51) Int. Cl. G06F 12/14

(52) U.S. Cl. 726/26

(57) ABSTRACT

In accordance with the aspects of the present invention the Software Installation Authorization System (SIAS) ensures that software is installed only in the computer for which it was intended is disclosed. It accomplishes this through the use of a compiled and scripted database hidden in a private partition on a USB Flash drive.

When the USB Flash drive is inserted into the computer for the first time it gathers unique and irrefutable identifying information about the computer and then releases the software installer from a container field in the database. Upon subsequent insertions the database gathers the same identifying information and compares it to the previously gather information before releasing the software installer.

If the information matches the software installer is released and installed. If the information does not match then the process is halted and the user is informed that the process will not proceed.

The software developer can assign an unlimited number of preset conditions into the database before its distribution. Examples of these conditions are: 1) Total number of installs, 2) Total number of computers to receive installs, etc.

### FIELD OF THE INVENTION

The present invention relates to software installation media, and more particularly to software installation via USB flash drives.

### BACKGROUND OF THE INVENTION

Software Developers have always struggled with the issue of unauthorized installations of their software, better known as Piracy. Currently, Developers sell their software on a CD along with a printed installation code. The purchaser must use this code in order to complete the installation and activate the software. It is the hopes of each Developer that the end-user will only install the software on one computer. But the end-user can make copies of the CD and installation code and then gives them away or sells as many copies as he or she chooses. These copies will install the software on other computers. Software Developers are cheated out of the sales price of each of these pirated copies.

### DESCRIPTION

This invention, the Software Installation Authorization System (SIAS) is comprised of a compiled scripted Database on a partitioned USB Flash Drive. This drive has two partitions, one public and one private. The Private partition and its contents are not viewable or accessible by the Operating System (OS) or end users. This partition cannot be copied. The public partition contains two files and is viewable. The first is the starter file associated with all USB Flash drives. This file installs drivers in the operating system to enable the computer to recognize the USB Flash Drive as a viable drive. The second file is an INF auto start file. The INF file automatically runs upon insertion of the USB flash Drive into a USB port in a computer. It directs the computer's OS to activate a file in the Private partition on the USB Flash Drive. This activated file is a compiled scripted Database. Every time this database is activated the first thing it does is run a search script that retrieves data associated with the computer's hardware. It then saves this data in the Database in the Private Partition of the USB Flash Drive.

The Database script collects the computer's BIOS serial number and the Motherboard's serial number. These numbers are unique and when used in combination with each other absolutely identifies the computer in which they are inalled as being unique. This database runs every time the USB Flash Drive is inserted.

During the first installation this data is retrieved and then written to the database. This data is retained in the database and used to validate future installs. The Database then opens a Container Field, which holds a Software Installer file. When opened, this Installer begins the installation of the Software Developer's software on the computer's hard drive.

During subsequent insertions of the USB Flash Drive, the Database will again gather the computer's BIOS and Motherboard serial numbers. It will then compare these numbers to the previously gathered numbers, which have been saved in the database. If the serial numbers from the subsequent installation match the BIOS and Motherboard's serial numbers from the initial installation, then the Database will proceed to make sure that all of the Software Developer's preset parameters have been met. If they have been met then the Database will open the container field and the software installer inside will activate and begin to install the Software Developer's software. If the serial number do not match, or the Developer's parameters are not met, then a display screen tells the user that the installation will not be allowed and the process terminates. Some examples of Developer parameter controls are: 1.) Total number of installs, 2.) Total number of re-installs.

When the Software Developer has 1.) Set installation parameters and, 2.) Loaded his installer into the Container, the Developer converts the database into a runtime application, better known as an executable program. It cannot be altered at this point but it can run when called upon by the INF file. This module is saved to the private partition of the USB Flash drive and becomes the below referenced Third Module.

The second module of the SIAS is a partitioned USB Flash drive (FIG. 2). This drive has two partitions; a public partition and a private partition. The public partition contains two files; a starter file and an INF file. The Starter file contains the driver instructions needed for the computer's OS to recognize the USB Flash Drive as an available drive. The INF file is an auto run file and it runs immediately upon insertion of the USB Flash Drive into the computer. This INF file directs the computer's OS to open the SIAS's Database that is located in the private partition on the USB Flash Drive.

The third module of the SIAS is the SIAS database (FIG. 3). This database is located on the USB flash Drive's private partition, which is not accessible and is not viewable from the computer's OS. The Database has a startup script, multiple Data Fields, and one Container Field. The script is a search script that calls for the computer's BIOS and Motherboard serial numbers. The Database can have multiple data fields. Two of the Data Fields are: 1.) BIOS serial number and 2.) Motherboard Serial Number. The Container Field is where the Software Developer's installation package is stored.

When this database opens, its first operation is to execute a script. A script is a series of instructions or commands that are executed in a specific order. This script runs a command that calls for the computer's BIOS serial number and Motherboard serial number. When the Database script acquires the serial numbers then the computer saves this data to the SIAS database.

If this is the first insertion of the USB Flash Drive into a computer, the data is written to the database and the database opens the Container field. The Software Developer's installer activates and installs the software on the computer's hard drive.

After its initial install, (FIG. 4) every time the USB Flash Drive is inserted into a computer the SIAS's Database will call for the BIOS and the Motherboard serial numbers from the computer and then check it for an exact match against the serial

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawing and FIGURES, wherein:

FIG. 1 is a perspective view of the process flow for the Software Developer's Interface.

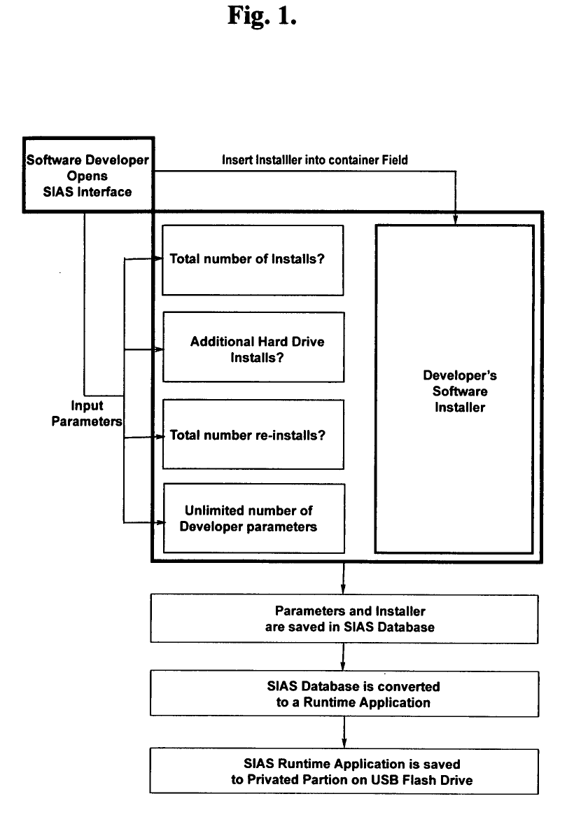

FIG. 2 is a plan view of a USB Flash Drive along with the two Partitions and associated files.

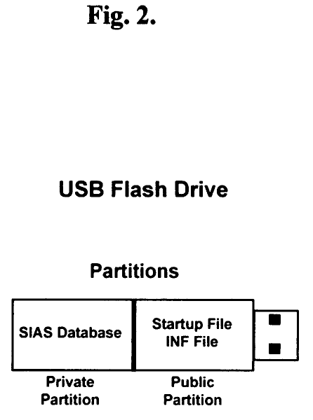

FIG. 3 is a plan view of the components of the SAIS Database.

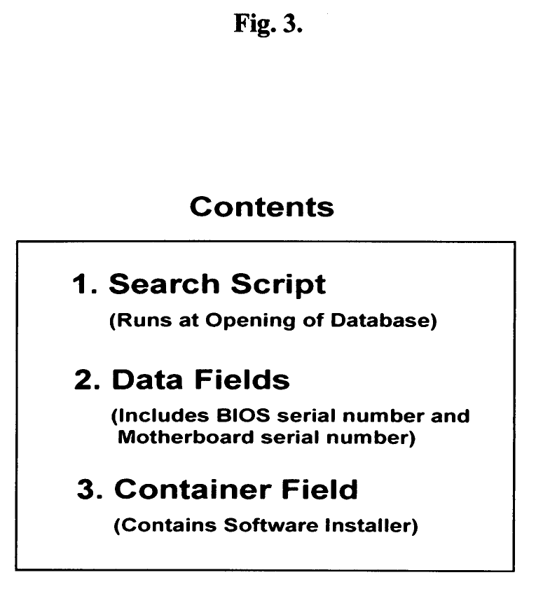

FIG. 4 is a perspective view of the process flow within the SAIS upon initial insertion of the USB Flash drive into a computer.

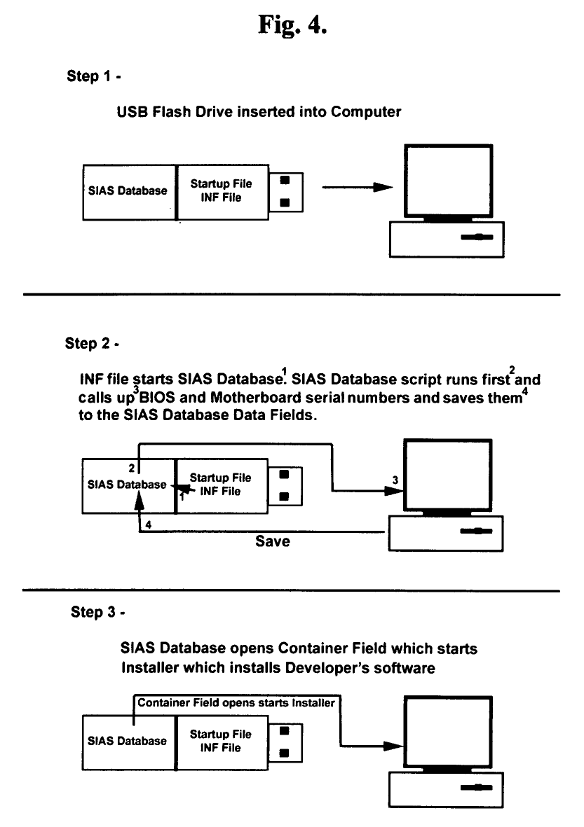

FIG. 5 is a perspective view of the process flow within the SAIS upon subsequent insertion of the USB Flash drive into a computer.

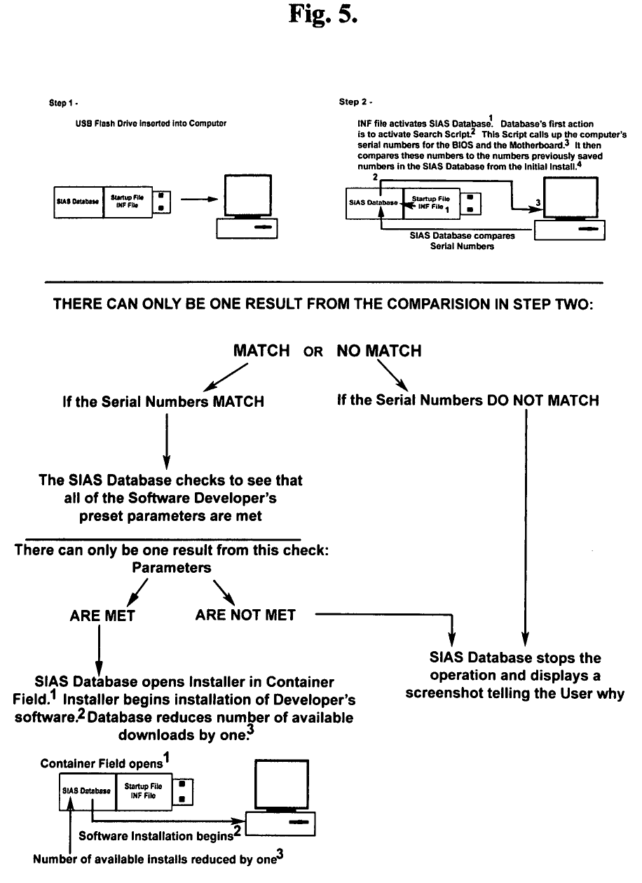

What is claimed is:

1. The Software Installation Authorization System (SIAS) allows a Software Developer to have complete control over installation and reinstallation of his/her software by validating that each installation will occur only under predefined conditions and only in the computer for which it was purchased. This process will eliminate unauthorized installations of “pirated” copies.
